(19) United States
(12) Patent Application Publication
(10) Pub. No.: US 2007/0153745 A1
(43) Pub. Date: Jul. 5, 2007

(54) System and method for link adaptation for WLAN voice transmission

(76) Inventors: Yishen Sun, Plainsboro, NJ (US); Aik Chindapol, Princeton, NJ (US); Justinian Rosca, West Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/511,555

(22) Filed: Aug. 29, 2006

Related U.S. Application Data
(60) Provisional application No. 60/756,010, filed on Jan. 4, 2006.

(51) Int. Cl. H04B 7/216

(52) U.S. Cl. 370/335

(57) ABSTRACT

Methods and apparatus for Link Adaptation in IEEE 802.11 Wireless Local Area Network (WLAN) are disclosed. Methods and apparatus for optimizing voice traffic in real-time over WLAN are also disclosed. The methods are based on state transitions and depend on transmission parameters. A Transmission Diagram and a Rate Sequence providing an optimal Link Adaptation are also disclosed.

### CROSS-REFERENCE TO RELATED APPLICATIONS

This application claims the benefit of U.S. Provisional Application No. 60/756,010, filed Jan. 4, 2006, which is incorporated herein by reference.

### BACKGROUND OF THE INVENTION

The present invention relates to voice transmission over WLAN. More specifically it relates to improvement of voice transmission over WLAN by Link Adaptation.

In typical voice transmission over wireless channels, delay, jitter, and packet error are main factors impacting the quality. Overall voice quality depends on tradeoffs between mechanisms that affect these factors. Link adaptation is one outstanding practical method to deal with such tradeoffs. IEEE 802.11 Wireless Local Area Network (WLAN) physical layers (PHYs) as described in standard document IEEE Std 802.11™ “Part 11: Wireless LAN Medium Access Control (MAC) and Physical Layer (PHY) specifications (reaffirmed)”, 2003, support multiple transmission rates. The PHY rate to be used for a particular frame transmission is solely determined by the transmitting station. The standard provides a high degree of flexibility on the PHY, allowing the Data Link Control (DLC) layer to choose transmission parameters with respect to the currently observed link quality. The transmission rate should be chosen in an adaptive manner since the wireless channel condition varies over time due to factors such as the station mobility, the time-varying interference, and location-dependent errors. In general, the higher the transmission rate, the higher the Signal-to-Noise Ratio (SNR) is required to maintain the same communication quality. The term Link Adaptation (LA) covers a variety of techniques for choosing transmission parameters according to the channel condition and Quality of Service (QoS) parameters.

Several WLAN chipsets on the market have their built-in link adaptation mechanisms. However, these solutions do not differentiate voice data from other non real-time data, and they try to maximize the throughput by choosing the highest possible transmission rate. As the result, voice packets may experience high level of packet loss and/or retransmission which also lead to extra delays.

One possible way to reduce the packet error rate is to use the most robust transmission rate, which is usually the lowest transmission rate available. In a lightly loaded network, this solution seems to work fine. However, once the network becomes more congested, such setting reduces the network throughput, increases the probability of packet collision and retransmission, and creates bandwidth starvation to other applications with lower priorities such as video and file transfer. In addition, the buffer at the access point sometimes gets overflowed because it takes a longer time to transmit voice frames while holding other packets in the queue. Therefore, some packets have to be dropped. For non real-time data, this is unlikely to be a problem since TCP/IP can initiate retransmissions and adjust to the congestion accordingly. However, for voice or video users, the quality can be degraded significantly.

Accordingly novel methods for maximizing the transmission rate over WLAN while maintaining the voice quality at a desirable level are required.

### SUMMARY OF THE INVENTION

One aspect of the present invention presents a novel method and apparatus that will provide Link Adaptation for voice transmission over WLAN.

It is another aspect of the present inventions to provide a method for Link Adaptation for a WLAN host in real-time data transmission of data packets for achieving optimal quality and transmission speed comprising: choosing an initial transmission Request Rate setting from a Rate Sequence; adjusting transmission parameters based on channel conditions and previous parameter settings; and selecting a new Request Rate for transmission of data packets based on the transmission parameters.

It is a further aspect of the present invention to provide a method wherein the initial transmission Request Rate is determined based on channel conditions observed and link layer error performance.

It is another aspect of the present inventions to provide a method wherein the real-time data is voice data.

It is a further aspect of the present invention to provide a method wherein the real-time data transmission takes place according to an IEEE 802.11 protocol.

It is another aspect of the present inventions to provide a method wherein a first transmission parameter is a Request Rate; a second transmission parameter is an Actual Rate; a third transmission parameter is an Retry Limit; and a fourth transmission parameter is an Retry Rate.

It is a further aspect of the present invention to provide a method wherein the Rate Sequence contains scalable or selected PHY rates, such as 54, 36, 24, 18, 12, 6 and 1 Mbps.

It is another aspect of the present invention to provide a method wherein the Request Rate is derived from a PER vs SNR curve.

It is a further aspect of the present invention to provide a method wherein the initial value of the Request Rate is set according to an estimated SNR of a current channel and a link layer PER constraint.

It is another aspect of the present invention to provide a method wherein selecting the Request Rate takes place according to a Transition Diagram which describes transitions between states based on transmission parameters and which include: a first state representing the Request Rate of the preceding state; a second state representing a Probation Higher Rate; a third state representing a Lower Rate; and a fourth state representing a Higher Rate.

It is a further aspect of the present invention to provide a method wherein the transitions include: a first transition from the first state to the second state; a second transition from the first state to the third state; a third transition from the second state to the first state; a fourth transition from the second state to the fourth state; and a transition wherein the state, not being the second state, remains unchanged.

It is another aspect of the present invention to provide a method wherein the Retry Rate of successive transmission attempts is set as one level fallback from a previous rate according to the Rate Sequence.

It is a further aspect of the present invention to provide a method wherein a pre-selected Request Rate is used when a Retry Limit is reached.

Apparatus that can perform Link Adaptation methods comprising a processor and application software operable on the processor is also provided in accordance with one aspect of the present invention. The application software can perform all of the methods described herein.

### DESCRIPTION OF THE DRAWINGS

FIG. 1 shows a system structure for WLAN Link Adaptation in accordance with one aspect of the present invention.

FIG. 2 provides BER vs. SNR curves for different transmission rates in accordance with another aspect of the present invention.

FIG. 3 provides PER vs. SNR curves for different transmission rates in accordance with a further aspect of the present invention.

FIGS. 4 and 5 show transition diagrams for Link Adaptation in accordance with another aspect of the present invention.

FIG. 6 shows two examples of transmission rates vs. channel conditions using Link Adaptation in accordance with a further aspect of the present invention.

FIG. 7 illustrates a system in accordance with yet a further aspect of the present invention.

FIG. 8 illustrates a functional block diagram of the link adaption processor.

### DESCRIPTION OF A PREFERRED EMBODIMENT

System Structure

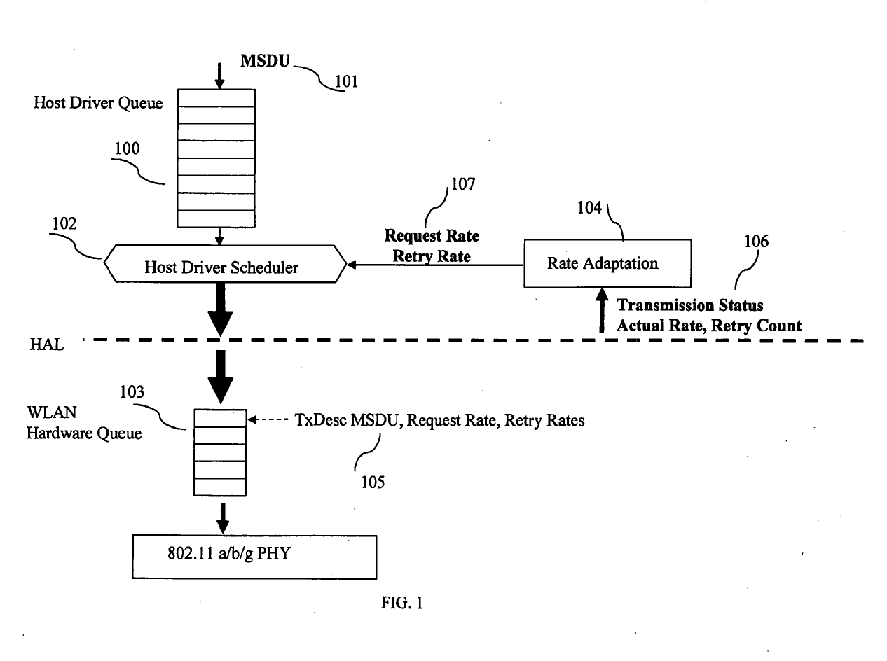

When the host receives a Medium Access Control (MAC) layer Service Data Unit (MSDU) to transmit from a network entity, the MSDU is inserted into the host driver queue. See FIG. 1 for a diagram. Once the host driver scheduler (102) is triggered, the MSDU (101) at the head of the non-empty queue (100) will be forwarded to the hardware queue (103) if permitted. Upon the time an MSDU is passed from the host driver to the hardware for transmission, the host software shall determine the rates at which the frame should be transmitted first and in successive retries in case of transmission failures. These rates are determined according to the most updated status of the Link Adaptation Module (104). All information is written into an information structure, which will be referred to as TxDesc (105). TxDesc is attached to the corresponding MSDU when passing from the software driver to the hardware. To be more specific, the rate of the first transmission attempt is equal to the Request Rate in a Link Adaptation module. If the original transmission fails, the frame will be retransmitted at pre-determined retry rates.

Upon the completion of frame transmission, the hardware notifies the host software the of transmission status, i.e., whether the frame was transmitted successfully or not. Upon a successful transmission, the hardware also communicates to the host software the rate at which the frame got through. This is reported as the Actual Rate. The feedback information from transmission completion (106) triggers the Link Adaptation (104) algorithm in the host software, and the Request Rate (107) is adjusted accordingly. It is worth pointing out that the number of retransmissions is also reported through Retry Count to the host driver, regardless of transmission success or failure. The Retry Count value will be used as one input to the algorithm which is one aspect of the present invention, and which differs from other existing approaches.

Terms and Process Components

A list is provided comprising terms that are going to be used frequently in the description of the present invention:
Request Rate: the rate that the frame is transmitted at for the first attempt;
Actual Rate: the rate at which the frame was transmitted successfully;
Initialization of the Request Rate: the selection of the initial value for the Request Rate when the Link Adaptation module is initialized;
Retry Limit: the maximum number of retransmissions for the same frame;
Retry Rates: the set of rates that a frame is transmitted at in successive retries;
Rate Sequence: the sorted order of rates which is followed when adjusting the Request Rate.

It can be seen from FIG. 1 that the LA module (104) determines the Request Rate (107) and successive retry rates based on the feedback information of transmission status (106), the Actual Rate and the Retry Count. Therefore, in the next section several aspects will be described of the Link Adaptation mechanism here presented as part of the present invention, which include the selection of the rate sequence, the retry rates, the initialization of the Request Rate, and the adjustment of the Request Rate.

Process Details

In this section, a new LA process which improves the system performance for voice applications is presented. Basic concepts of the approach are described and compared with other LA processes implemented so far.

Rate Sequence

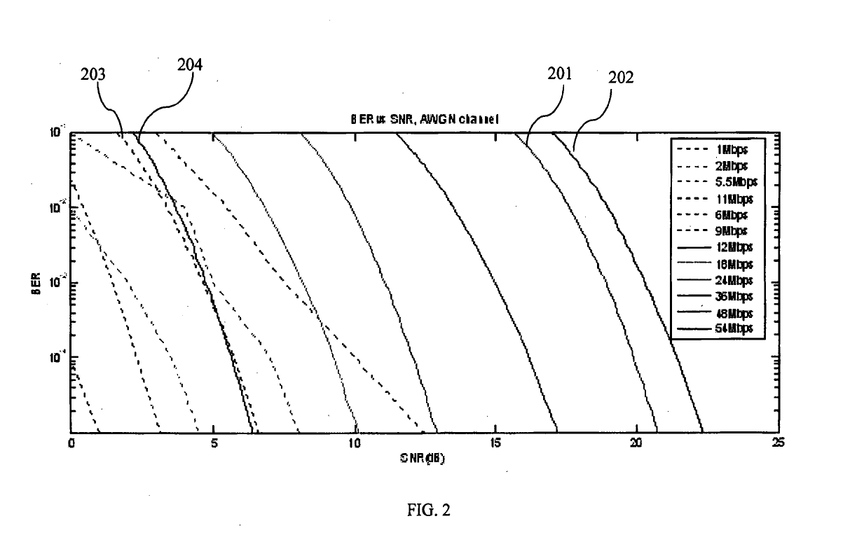

The common practice of the rate sequence selection is to sort all available rates according to the magnitude so that the rates are sequenced in order without skipping any available rates. The justification of the approach is based on the assumption that a lower rate is more robust to channel degradation. Here ‘more robust’ means that the bit error rate (BER) is smaller, thus the packet error rate (PER) is smaller and the packet is more likely to be received error free. However, this assumption is not always true. This can be seen from FIG. 2, which shows the BER vs SNR curves for all transmission modes of 802.11b/g. The PER curves can be derived directly from the BER curves.

Several observations can be made from reading these curves. First, the SNR margin between 48 Mbps (201) and 54 Mbps (202) transmission modes is only 1dB. Second, 12 Mbps (204) and. 9 Mbps (203) have similar BER performance. The reason behind is that, although QPSK has worse error performance than BPSK, the worse performance of the rate−¾ convolutional code compared to the rate−½ convolutional code has the more dominating effect. Third, there is cross area between 802.11b and 802.11g modes, which implies that lower transmission rate might not achieve lower BER.

Therefore the following criteria for the rate sequence selection are presented:
1. the BER vs. SNR performance should be considered to determine the rate sequence, instead of sorting available rates according to the rate values only;
2. when both 12 Mbps and 9 Mbps are supported, the 9 Mbps mode should be skipped;
3. when 54 Mbps, 48 Mbps and 36 Mbps are all supported, the 48 Mbps mode should be skipped;
4. when all PHY rates of 802.11b and 802.11g are available, the rate sequence should be {54, 36, 24, 18, 12, 6, 1} Mbps.

Retry Rates

For a given Request Rate, the retry rates of successive transmissions is set as one level fallback from the previous rate according to the rate sequence. In addition, the most robust rate is used when retry limit is reached. This special treatment guarantees frame delivery to the maximum extent, and provides more protection against channel fluctuation. By reducing packet loss and retransmissions, the end to end delay decreases and the voice quality is expected to improve.

Because of both modifications, the retry rate is one level or multiple levels fallback among all available rates, instead of the simple one-level fallback or no fallback at all in most existing implementations. For example, if the Request Rate is 54 Mbps and the retry limit is 2, then the transmission rates of the first and the second retry are 36 Mbps and 1 Mbps respectively.

Initialization of the Request Rate

A good initial value for the Request Rate should take into account the present channel condition, so that the LA algorithm may converge to the appropriate rate faster, and packet losses are minimized. Therefore, it is one aspect of the present invention that the initial value of the Request Rate should be set according to the estimated SNR of the current channel and the link layer PER constraint. Here the link layer PER is determined by both the application layer PER bound, which is usually 1% for voice traffic, and the retry limit. For example, if the retry limit is 2, the link layer PER bound is about 21.54%.

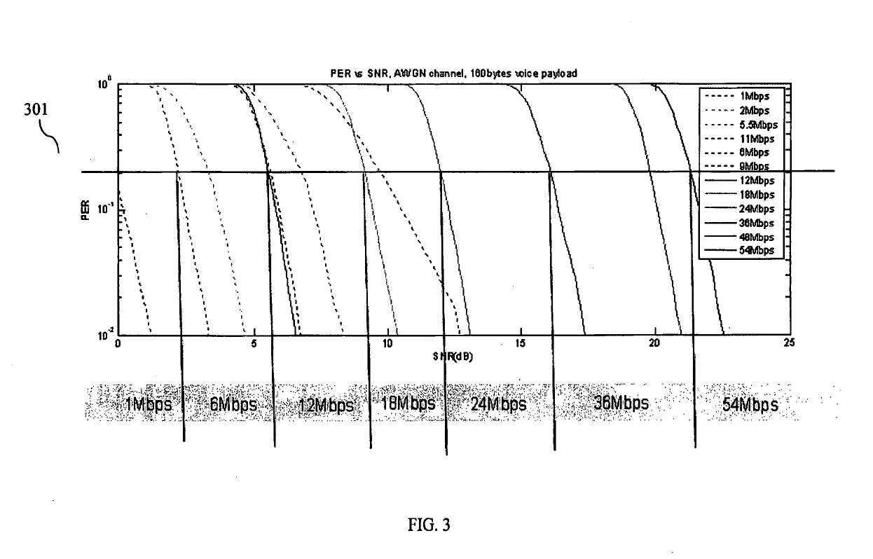

FIG. 3 shows PER vs SNR curves in Additive White Gaussian Noise (AWGN) channel, assuming the voice payload size is 160 bytes. Set the PER bound at 20% as indicated by the horizontal black line (301), the initial rates under different SNRs are suggested at the bottom of the figure. For example, when the estimated SNR is between 16 dB to 21 dB, the Request Rate should be initialized to 36 Mbps.

Adjustment of the Request Rate

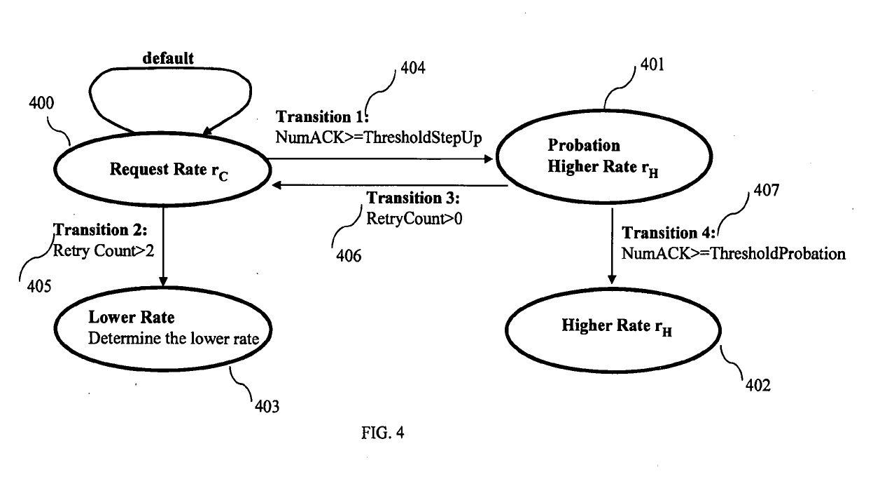

FIG. 4 outlines the adjustment criterion of the approach of the present invention through a state-transition diagram. There are 4 transitions as shown in FIG. 4: Transition 1 (404): from a state Request rate (400) to a state Probation Higher Rate (401); Transition 2 (405): from a state Request rate (400) to a state Lower Rate (403); Transition 3 (406): from a state Probation Higher rate (401) to a state Request rate (400); and Transition 4 (407): from a state Probation Higher rate (401) to a state Higher Rate (402); The transition conditions are the Retry Count value reported after the transmission completion of each frame, and the counter NumACK which counts the number of continuous transmission success. Here a frame transmission is considered as a success if and only if Retry Count is equal to 0.

The Request Rate is reduced if Retry Count is not 0. The lower rate is determined by both the value of Retry Count and the Actual Rate. It might be multiple levels fallback from the Request Rate. The algorithm also tries to increase the Request Rate if NumACK exceeds a threshold value, which is denoted as ThresholdStepUp. It always steps up to the next higher rate as specified in the rate sequence, and enters the probation state (401) first, which is a transient state. While in the probation state, the host will either return to the previous rate if there is any transmission failure at the newer rate, or decide to finalize the rate stepup if the number of transmission success in a row is greater than another threshold, ThresholdProbation.

The value of ThresholdStepUp is also adjusted adaptively during the entire process. A small ThresholdStepUp value is preferred if the channel changes fast, because one would want to track the fluctuation closely and increase the default rate as soon as possible when the channel becomes better. However, if the channel condition does not change at all, or changes very slowly, the host will still try to use a higher rate every ThresholdStepUp successfully transmitted packets. This results in increased retransmission attempts and thus decreases the application throughput. Therefore, a larger ThresholdStepUp is more suitable for a static channel. To address this tradeoff, ThresholdStepUp is set to a small default value ThresholdStepUpDefault during the initialization. Once transition 3 happens, which means the previous decision of increasing rate is not working, ThresholdStepUp is doubled so that the algorithm will be more patient in increasing the rate next time. This value is also bounded by ThresholdStepUpLimit front above. When transition 2 happens, ThresholdStepUp is reset to the default value, because the channel is changing.

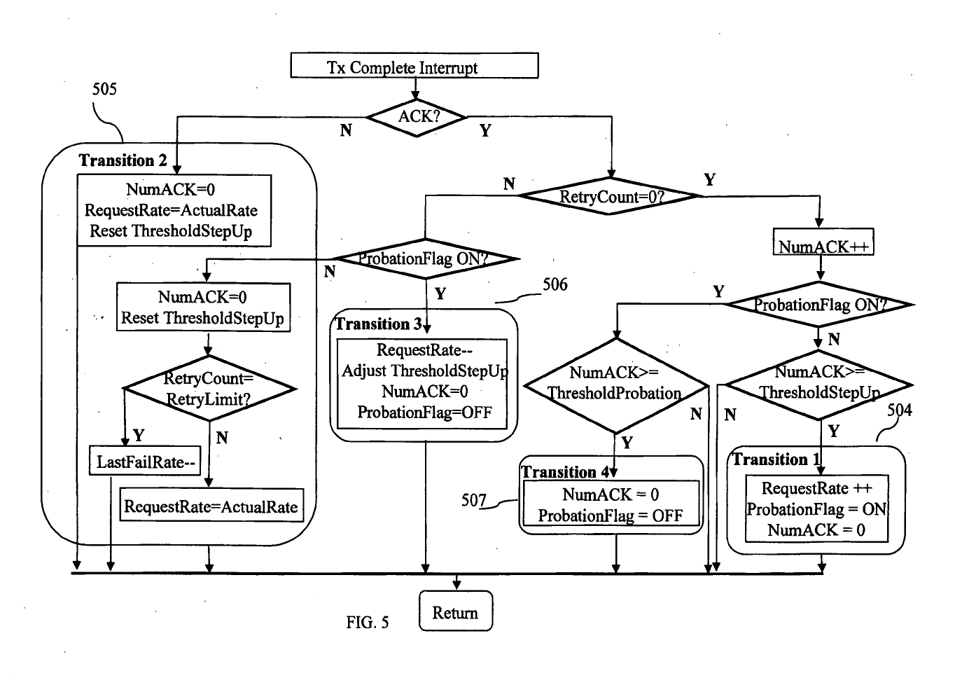

An important feature of the algorithm of the present invention is that the adjustment process takes into account the feedback information on Retry Count value, which differs from existing implementations. In addition, if the rate fallback is needed, the new Request Rate may be multiple levels lower than the previous rate, instead of only one level at a time as in other mechanisms. This enables the algorithm to respond faster to the rapid channel degradation, so that successive packet losses can be avoided. More details of the rate adjusting process can be found in FIG. 5, where the block 504, 505, 506 and 507 correspond to Transition 1, Transition 2, Transition 3 and Transition 4 respectively. They also correspond to the transition operation with the same transition number as in FIG. 4 wherein 404 corresponds with 504, 405 corresponds with 505, 406 corresponds with 506 and 407 corresponds with 507.

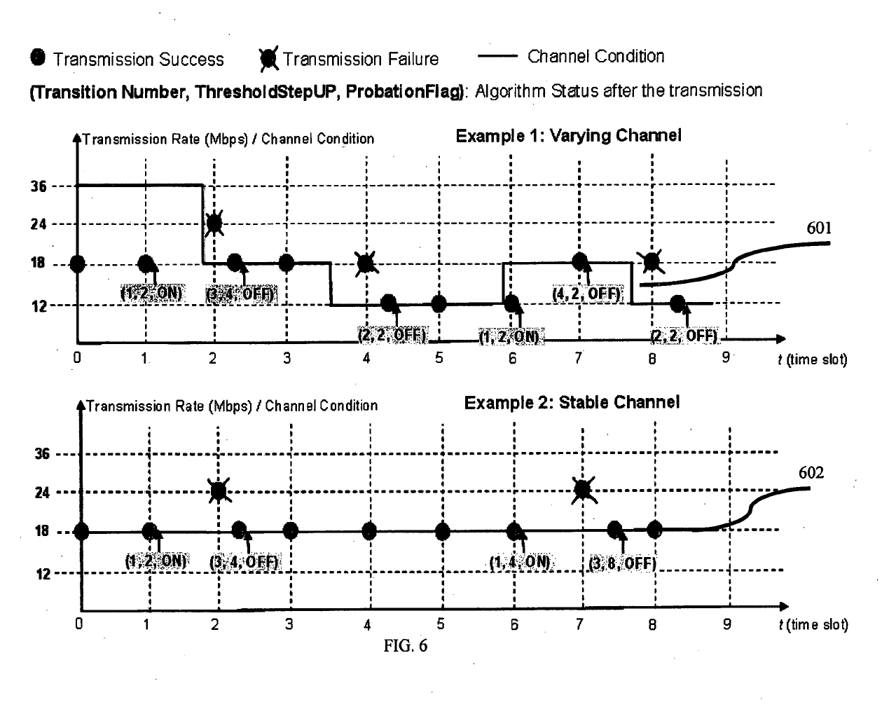

To better illustrate the main idea of the algorithm of the present invention, two examples are provided and illustrated in FIG. 6. Example 1 focuses on the varying channel, while example 2 aims at showing the algorithm status for the static channel. For simplicity, the channel condition is marked in terms of rate using lines 601 and 602 in FIG. 6. The assumption here is that the frame can get through if and only if the transmission rate is no greater than the channel condition rate. The X-axis is the time line in units of time slot, and each time slot corresponds to the inter-arrival time between frames, e.g., 10 ms. Dots in the same time slot represent the initial attempt and the following retries of the same frame. The rest of the examples are self-explained in FIG. 6.

Conclusion

From the here provided analysis it is clear that the proposed link adaptation algorithm can improve the voice transmission quality over WLAN, while keeping the transmission rate at a higher level. This is made possible through the following features:
The rate sequence is selected based on the BER vs. SNR performance and the retry limit. Several PHY modes are skipped because of the fact that they cannot provide enough improvement margin on the error robustness. Therefore, the number of retransmissions is expected to be reduced, and the end to end delay decreases consequently.
The last retry uses the most robust rate available. This procedure guarantees the frame delivery to the maximum extent, while allowing more aggressive rates to be used in previous attempts.
The initial value of the Request Rate is determined based on the channel condition observed and the link layer PER constraint. Therefore, the algorithm begins from a good starting point, and adjusts adaptively thereafter.
The adjustment of the Request Rate takes into account both the slow fluctuation and the rapid degradation of the channel condition. When the channel becomes worse, the link adaptation algorithm signals the degradation from the increasing number of non-zero Retry Count, and decreases the rate to the appropriate level. When the channel is relatively static, the adaptive tuning of ThresholdStepUp value can avoid unnecessary transmission attempts with too aggressive rates. The usage of feedback information on Retry Count in link adaptation decision is a new idea which hasn't been seen from existing literature or products.

The following applications of the present invention are contemplated and include, but are not limited to:
WLAN handsets, where voice application is the major traffic sources;
WLAN access point, where differentiated quality of service (QoS) is required for different traffic access categories;
Transmission of other types of traffic which are loss-sensitive or delay-sensitive.

The methods which are an aspect of the present invention are used in WLAN based systems. The methods can be implemented as part of a WLAN system. They can be an integral part of a WLAN system or can be implemented as a separate Link Adaptation unit. The implementation can be on a processor such as a microprocessor. The methods can also be implemented in discrete components or realized as an individual electronic integrated circuit. The Link Adaptation methods can also be implemented as part of an integrated circuit.

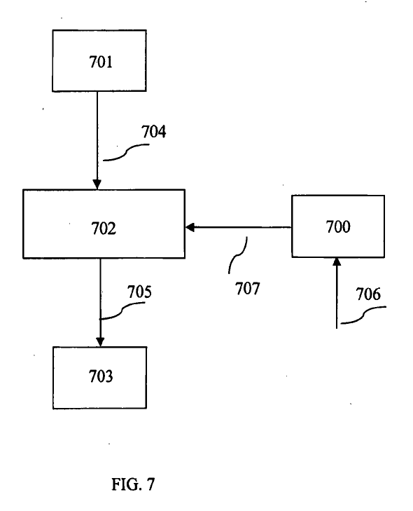

FIG. 7 illustrates a system in accordance with one aspect of the present invention. A first processor 702 receives data 704, which can be voice data coming from a source 701. The data is delivered in packet form 705 to a constrained communication channel 703. The quality and speed of the data (the transmission rate) is determined by a signal 707 in accordance with one or more aspects of the present invention. The methods of the present invention can be executed by a computer program implemented in a processor 700. The processor 700 can receive input 706 reflecting the conditions of the transmission channel and the status of the first processor 702, for example with the actual Retry Count. Accordingly the methods of the present invention can be implemented in a processor. To one skilled in the art it should be clear that the processor 700 can be shared with other programs. Aspects of the present invention can also be implemented in a distributed fashion in several processors or for example in different parts of an integrated circuit. However functionally it may appear that the Link Adaptation methods of the present invention are implemented as a computer program on a single processor.

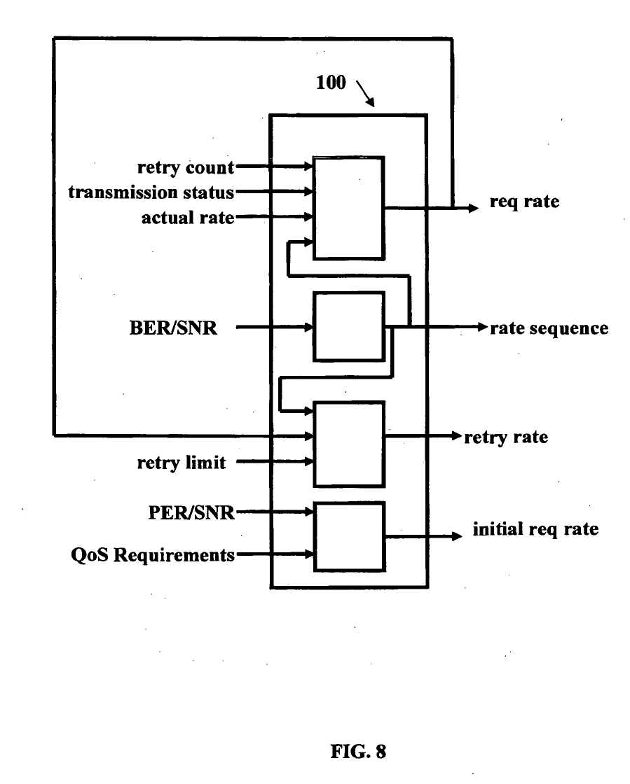

In accordance with one aspect of the present invention, as illustrated in FIG. 8, a link adaptation processor 100 is provided. As previously mentioned, the processor 100 can be any combination of processor types and application software.

The following inputs are provided to the processor 100: retry count, transmission status, actual rate, BER information, SNR information, retry limit, PER information and Quality of Service (QoS) requirements. Transmission status indicates whether the transmission was okay or not.

An initial request rate is determined as a function of the PER information, the SNR information and the QoS requirements. A rate sequence is determined as a function of the BER information and the SNR information. A request rate is determined as a function of retry count, transmission status and actual rate. A retry rate is determined as a function of request rate, rate sequence and retry limit.

In accordance with a preferred embodiment, the determinations by the processor are performed simultaneously. This means the processor performs the determinations in sequence so that the determinations are made at approximately the same time.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method of link adaptation processing with a processor, comprising:
inputting a retry count to the processor;
inputting one or more inputs to the processor; and
determining a request rate as a function of the retry count and the one or more inputs.

2. The method of claim 1, wherein the one or more inputs includes an actual rate, a rate sequence and a transmission status.

3. The method of claim 2, comprising:
inputting the request rate, a rate sequence and a retry limit to the processor; and
determining a retry rate as a function of the request rate, the rate sequence and the retry limit to the processor.

4. The method of claim 2, comprising:
inputting BER information and SNR information to the processor; and
determining a rate sequence as a function of the BER information and the SNR information.

5. The method of claim 4, wherein the rate sequence specifies a sequence that skips one or more available rates.

6. The method of claim 2, comprising:
inputting PER information, SNR information and QoS requirements to the processor; and
determining an initial retry rate as a function of the BER information, the SNR information and the QoS requirements.

7. The method of claim 4, comprising:
inputting the request rate, the rate sequence and a retry limit to the processor; and
determining a retry rate as a function of the request rate, the rate sequence and the retry limit to the processor.

8. The method of claim 7, comprising:
inputting PER information and QoS requirements to the processor; and
determining an initial retry rate as a function of the BER information, the SNR information and the QoS requirements.

9. The method of claim 8, wherein the determining steps are performed simultaneously.

10. A method of link adaptation processing with a processor, comprising:
inputting a request rate, a rate sequence and a retry limit to the processor; and
determining a retry rate as a function of the request rate, the rate sequence and the retry limit to the processor.

11. The method of claim 10, wherein the rate sequence specifies a sequence that skips one or more available rates.

12. The method of claim 10, wherein a last retry rate is a function of the retry limit.

13. The method of claim 10, comprising:
inputting a retry count to the processor;
inputting one or more inputs to the processor; and
determining a request rate as a function of the retry count and the one or more inputs.

14. The method of claim 10, comprising:
inputting BER information and SNR information to the processor; and
determining a rate sequence as a function of the BER information and the SNR information.

15. The method of claim 14, wherein the rate sequence specifies a sequence that skips one or more available rates.

16. The method of claim 10, comprising:
inputting PER information, SNR information and QoS requirements to the processor; and
determining an initial retry rate as a function of the BER information, the SNR information and the QoS requirements.

17. The method of claim 16, comprising:
inputting PER information, SNR information and QoS requirements to the processor; and
determining an initial retry rate as a function of the BER information, the SNR information and the QoS requirements.

18. The method of claim 17, wherein the determining steps are performed simultaneously.

19. A method of link adaptation processing with a processor, comprising:
inputting BER information and SNR information to the processor; and
determining a rate sequence as a function of the BER information and the SNR information;
wherein the rate sequence specifies a sequence that skips one or more available rates.
